(19) United States
(12) Patent Application Publication
(10) Pub. No.: US 2014/0050545 A1
(43) Pub. Date: Feb. 20, 2014

(54) MULTIPURPOSE DRILLING TOOL AND ASSOCIATED CASE

(71) Applicant: AIRCELLE, Gonfreville L'Orcher (FR)

(72) Inventors: Gregory BAILLEUL, Ecrainville (FR); Christian Staes, Epouville (FR); Sylvain Le Guen, Parc D'Anxtot (FR); Cyrille Mutel, Le Grand Quevilly (FR)

(73) Assignee: AIRCELLE, Gonfreville L'Orcher (FR)

(21) Appl. No.: 14/060,732

(22) Filed: Oct. 23, 2013

Related U.S. Application Data
(63) Continuation of application No. PCT/FR2012/050896, filed on Apr. 24, 2012.

(30) Foreign Application Priority Data
May 4, 2011 (FR) 1153830

(51) Int. Cl. B23B 51/10

(52) U.S. Cl. CPC B23B 51/107
USPC 408/201

(57) ABSTRACT

A multipurpose drilling tool includes a guide head, a drilling cutter, and a shank for mounting on a chuck. These three elements are assembled with one another removably so as to allow each of them to be replaced by a similar element of different dimensions. In particular, the drilling cutter has a bore, and the guide head includes a pilot that comes into abutment at the entrance of the bore and a stem that passes along the bore and is screwed into the mounting shank.

### CROSS-REFERENCE TO RELATED APPLICATIONS

This application is a continuation of International Application No. PCT/FR2012/050896, filed on Apr. 24, 2012, which claims the benefit of FR 11/53830, filed on May 4, 2011. The disclosures of the above applications are incorporated herein by reference.

### FIELD

The present disclosure relates to a multipurpose drilling tool, and an associated tool case.

### BACKGROUND

The statements in this section merely provide background information related to the present disclosure and may not constitute prior art.

Operations for drilling parts in particular made from composite or metal materials with alloys of aluminum, titanium and other materials must be done with great precision, so as to comply with the most demanding specifications, such as those in force in the aeronautics field.

In this particular technical field, the operations for drilling panels, in particular metal panels, are necessary to allow the passage of cables, ducts or other members, or to allow the placement of fastening members (for example, screws or rivets) for example making it possible to assemble several panels to each other.

Such drilling operations in particular take place in the production of nacelles for aircraft turbojet engines.

These drilling operations are done using drilling tools mounted on rotary chucks, the diameter of said drilling tools being chosen as a function of each need.

It may happen that a drilling is defective, i.e., the drilling is not done at the desired diameter (so-called “nominal” diameter), for example due to an incorrect choice of drilling tools.

Another type of defect may be a non-circular drilling, caused by vibrations of the drilling tool.

Traditionally, when such a defect appears, drilling is done with a diameter larger than the defective drilling, and a repair ring is placed on the orifice thus obtained, the diameter of which is slightly larger than that of said orifice in metal materials (in composite materials, the diameter of the ring is smaller than the diameter of the hole), and whereof the inner diameter is equal to the initially desired drilling diameter (nominal diameter).

The fastening of the ring on the edge of the orifice is done by gluing in composite materials, and bracing in metal materials, or through any other suitable means.

Generally, these operations to repair a drilling defect require the intervention of specialized companies, having suitable tools for all possible defect configurations.

### SUMMARY

The present disclosure provides a drilling tool allowing an operator to resolve an observed drilling defect himself, irrespective of the configuration of that drilling defect.

The present disclosure provides a multipurpose drilling tool, comprising:

a guide head,

a drilling cutter, and

a shank for mounting on a chuck,

these three elements being assembled with one another removably so as to allow each of them to be replaced by a similar element of different dimensions, said drilling cutter having a bore and said guide head having a pilot that comes into abutment at the entrance of said bore and a stem that passes along said bore and is screwed into said mounting shank.

Owing to these features, and by providing a tool case comprising heads, cutters and shanks of different dimensions, it is possible to produce many dimensional combinations of those elements, which make it possible to deal with any drilling defect configuration, without it being necessary to call on an outside specialized company.

The multipurpose drilling tool according to the present disclosure is obtained with only three parts that are very easy to separate from each other, as well as to assemble: each of the elements making up the tool may be replaced simply by unscrewing the stem from the shank.

According to other optional features of the multipurpose tool according to the present disclosure:

the drilling cutter itself comprises a mounting cylinder, crossed through by said stem, and coming into abutment against said shank;

said cylinder and said shank comprise complementary tapered shapes, allowing an abutment of the cone-on-cone type: such an abutment allows complete immobilization of said parts in rotation relative to one another, once the stem is screwed inside the shank;

said head and said shank each comprise two flats so as to be able to tighten and loosen them with two flat keys or clamps.

The present disclosure also relates to a toolbox, comprising guide heads, drilling cutters and mounting shanks of different dimensions, that can be assembled to form a drilling tool as described above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an exploded perspective view of a drilling tool according to the present disclosure,

FIG. 2 shows a side view of the drilling tool of FIG. 1, in the assembled state, the hidden parts being shown, and

FIG. 3 shows a perspective view of the drilling tool of FIG. 2.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As shown in all of these figures, the drilling tool includes three parts, i.e.: a guide head 1, a drilling cutter 3, and a shank 5 for mounting on a chuck (not shown).

More specifically, the guide head 1 includes an end forming a pilot 7, and a stem with a smaller diameter 9, including a threaded tip 11.

The drilling cutter 3 includes a cutter 13 strictly speaking, topped by a mounting cylinder 15.

As shown in particular in FIG. 2, the cutter 13 and the mounting cylinder 15 are crossed through over their entire length by a bore 17 capable of receiving the stem 9.

The mounting shank 5 includes a threaded cavity 19, as shown in FIG. 2, said cavity being able to receive the threaded end 11 of the stem 9 by screwing.

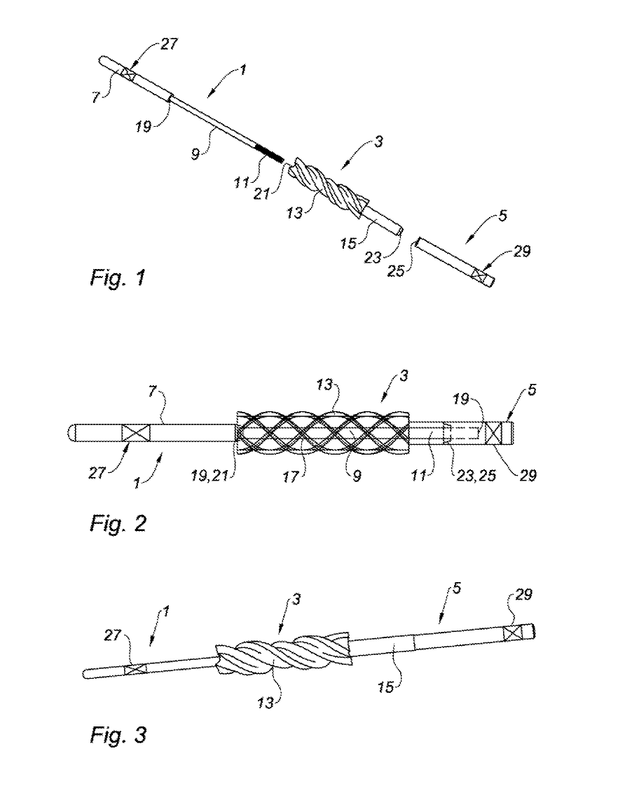

As shown in particular in FIGS. 1 and 2, the pilot 7 and the cutter 13 on the one hand, and the mounting cylinder 15 and the mounting shank 5 on the other hand, include tapered shapes, 19, 21 and 23, 25, respectively, capable of forming cone-on-cone type abutments when the stem 9 is screwed and tightened inside the threaded cavity 19 of the shank 5.

The materials forming each of the elements 1, 3, 5 are suitable for performing drilling operations, in particular inside panels made from a metal alloy, such as panels made from an aluminum or titanium alloy, or panels made from composite materials, such as acoustic absorption similar structures.

As an example, the head 1 and the shank 5 can be made from steel, and the cutter 3 may be made from tungsten carbide.

In one form, the head 1 and the shank 5 each comprise two flats 27, 29 so as to be able to tighten and loosen them with two flat keys or clamps.

The usage mode and advantages of the drilling tool described above are as follows.

During an operation for drilling a metal or composite panel, an unintentional error may be committed, such that the diameter of the hole made is inappropriate: a pure and simple error in diameter, or a non-circular hole obtained following uncontrolled vibrations of the drilling tool, for example.

To resolve this error, a new drilling operation should be performed making it possible to place a repair ring, said ring having an inner diameter corresponding to the desired diameter (called “nominal” diameter).

To that end, a toolbox (not shown) is used, having a full range of guide heads 1, drilling cutters 3 and mounting shanks 5, with different diameters and lengths.

A guide head 1 is chosen having a pilot whereof the diameter corresponds to the nominal diameter, and whereof the length makes it possible, if necessary, to cross through the layers without material without there being any risk of movement of the drilling tool.

For the cutter 3, a cutter is chosen having a diameter larger than that of the hole erroneously made, and smaller than that of the outer diameter of the repair ring that will be used in the case of a metal part. In the case of a composite part, a cutter will be chosen having a diameter larger than that of the hole erroneously made, and larger than that of the outer diameter of the repair ring.

Lastly, regarding the mounting shank 5, a shank will be chosen having a length compatible with the configuration of the location where the drilling is to be done: there may in fact be particular length constraints, in particular when using angle return rotatable driving systems of the drilling tool.

Once the suitable guide head 1, drilling cutter 3 and mounting shank 5 have been chosen, these three elements will be assembled together, bypassing the stem 9 of the head 1 inside the bore 17 of the cutter 13 of the mounting cylinder 15, such that said stem 9 emerges from said cylinder and can screw inside the cavity 19 formed in the shank 5.

A tightening torque is applied to this screwing, such that the tapered shapes 19, 21 and 23, 25 abut against each other, so as to prevent a relative rotation of each of the elements 1, 3, 5.

The mounting shank 5 is then placed engaged inside a rotating chuck (not shown), and said chuck is brought to the erroneously produced hole needing to be corrected.

The pilot 7 thus bears against the edges of said hole (or optionally against the edges of another hole situated aligned with the defective hole), and the drilling tool is lowered until the cutter 3 re-bores the defective hole.

The piercing tool may then be removed from the new hole thus formed, after which the repair ring may be fastened on the edge of said new hole, the inner diameter of which corresponds to the nominal diameter, i.e., the diameter of the hole one initially wished to produce.

The repair ring (not shown) may be fastened using any known means on the edge of the hole produced, for example by bracing or gluing.

As will be understood in light of the preceding description, the drilling tool according to the present disclosure makes it possible, extremely simply, to produce all combinations of diameters and lengths of the guide head 1, drilling cutter 3 and mounting shank 5.

In this way, it is possible to intervene very simply in all defective drilling situations, with great precision given the guide function performed by the pilot 7, which bears on the defective hole, or on another hole situated aligned with the latter.

The multipurpose drilling tool according to the present disclosure thus makes it possible to intervene urgently on panel production chains, in particular intended to form aircraft structures.

Such a drilling tool is particularly suited for the repair of defective bores produced in composite sandwich structures made from carbon and aluminum, in particular used to manufacture acoustic absorption panels, intended to be placed inside the nacelles of aircraft turbojet engines.

Of course, the present disclosure is in no way limited to the form described and illustrated, provided solely as an example.

What is claimed is:

1. A multipurpose drilling tool, comprising:
a guide head;
a drilling cutter; and
a shank for mounting on a chuck, these three elements being assembled with one another removably so as to allow each of them to be replaced by a similar element of different dimensions,
wherein said drilling cutter has a bore, and said guide head has a pilot that comes into abutment at an entrance of said bore and a stem that passes along said bore and is screwed into said shank.

2. The multipurpose drilling tool according to claim 1, wherein the drilling cutter itself comprises a mounting cylinder, crossed through by said stem, and coming into abutment against said shank.

3. The multipurpose drilling tool according to claim 2, wherein said cylinder and said shank comprise complementary tapered shapes, allowing an abutment of a cone-on-cone type.

4. The multipurpose drilling tool according to claim 2, wherein said pilot and said drilling cutter comprise complementary tapered shapes, allowing an abutment of a cone-on-cone type.

5. The multipurpose drilling tool according to claim 1, wherein said guide head and said shank each comprise two flats able to tighten and loosen them with two flat keys or clamps.

6. A toolbox, comprising guide heads, drilling cutters and mounting shanks of different dimensions, that can be assembled to form a multipurpose drilling tool according to claim 1.
